(19) United States
(12) Patent Application Publication
(10) Pub. No.: US 2011/0031047 A1
(43) Pub. Date: Feb. 10, 2011

(54) IN-MOTION INDUCTIVE CHARGING SYSTEM HAVING A WHEEL-MOUNTED SECONDARY COIL

(75) Inventor: Walter L. Tarr, Seattle, WA (US)

Correspondence Address: BLACK LOWE & GRAHAM, PLLC, 701 FIFTH AVENUE, SUITE 4800, SEATTLE, WA, 98104, US

(73) Assignee: TARR ENERGY GROUP, LLC, Seattle, WA (US)

(21) Appl. No.: 12/847,670

(22) Filed: Jul. 30, 2010

Related U.S. Application Data
(60) Provisional application No. 61/231,202, filed on Aug. 4, 2009.

(51) Int. Cl. B60K 1/00; B60L 9/00

(52) U.S. Cl. 180/65.1; 191/10

(57) ABSTRACT

An exemplary embodiment provides electrical energy to an electric vehicle travelling along a roadway enabled with electric energy transmitting modules. The electric energy is transmitted via a magnetic field for use by the electric vehicle via electric energy receiving modules in the wheels of the electric vehicle.

PRIORITY CLAIM

This Application claims the benefit of Provisional Application Ser. No. 61/231,202, filed on Aug. 4, 2009 and entitled IN-MOTION INDUCTIVE CHARGING SYSTEM HAVING A WHEEL-MOUNTED SECONDARY COIL, the contents of which is hereby incorporated by reference in its entirety.

### FIELD

This invention relates generally to an inductive charging system to charge the battery of an electric vehicle including an external high power energy provider (primary coil) which supplies electrical energy to the electric vehicle by means of an energy receiving component (secondary coil) in the vehicle, and more specifically to an energy receiving component embedded in and/or within the wheels of the vehicle.

### BACKGROUND

Electric vehicles are known in the art, but in general the vehicle operably includes, among other things: an electric drive means coupled to at least one of a front or rear suspension system for driving the front and rear wheels; a recharging energy storage system (battery, ultracapacitor, a combination thereof or other energy storage solutions) for storing and delivering electrical energy; and an onboard power controller means for receiving electrical energy from an energy receiving component and directing the electric energy to the recharging energy storage system and for selectively delivering electrical energy from said recharging energy storage system to said electric drive means in order to provide operating power to an electric vehicle.

Current electric vehicles generally require recharging of the onboard battery while the vehicle is stationary. (See, e.g., U.S. Pat. No. 5,617,003 to Odachi and U.S. Pat. No. 5,929,599 to Watanabe, et al.) One commercial embodiment of an electric vehicle, the Tesla Roadster, requires recharging as often as every 244 miles. (See www.teslamotors.com.) While recharging an onboard battery while the electric vehicle is in motion has been contemplated, prior art solutions have proven too inefficient to be feasible. (See, e.g., U.S. Pat. No. 5,311,973 to Tseng, et al., and U.S. Pat. Nos. 5,573,090 and 5,669,470 to Ross.) Electric buses, for the most part, rely on overhead wires, as do some light rail solutions. These are generally not feasible for private vehicles. Other electric light rail solutions utilize electromagnetic induction systems, but the induction systems are usually designated tracks, and are therefore generally limited to the designated rapid transit solutions. Electric energy induction systems for roadway vehicles are known. For example, prototypes of electric passenger vehicles and electric buses exist.

Electromagnetic induction transfers energy from a primary coil to a secondary coil. The primary coil generates a magnetic field. When the secondary coil is in that field, the primary coil induces a current in the secondary coil. Electromagnetic induction efficiently transfers electrical energy only over a relatively short range due to the distribution of the magnetic field surrounding the primary coil. In instances where the secondary coil is distant from the primary coil, electromagnetic induction inefficiently transfers electrical energy.

Electric energy transfer for experimentally powering electric automobiles and buses is a high power application (>10 kW). High power levels are required for rapid recharging and high energy transfer efficiency both for operational economy and to avoid negative environmental impact of the system. An experimental electrified roadway test track built circa 1990 achieved 80% energy efficiency while recharging the battery of a prototype bus at a specially equipped bus stop. The bus in this example was outfitted with an extendable and retractable secondary coil. The gap between the transmit and receive coils was designed to be approximately 10 cm during induction because of the general decrease in energy transfer over greater distances particularly of these types of high power applications. The secondary coil was then retracted after energy transfer and before the bus began moving because a vehicle generally requires more than 10 cm of ground clearance to operate safely.

Numerous patents have described transmission systems disposed beneath a road way surface. Commercial implementation of high energy inductive systems must overcome the problem of efficient energy transfer across an airspace during movement of the vehicle. For example, the alignment and distance between the primary coils of the energy source and secondary coils in the energy receiving systems must be considered so that the transfer works at peak efficiency while the vehicle is in motion. A prior art resonant inductive system (U.S. Publication Serial No. 20080265684) discloses a receiving device mounted on the undercarriage of the electric vehicle. However, this system suffers from the lack of a consistent space between the road and the vehicle due to variables between different makes and models of vehicles such as size, shape, the height of a vehicle, and so forth. Also, due to the variability between vehicles, it seems likely that any actual implementation of the disclosed system would require that the primary coils would be on the surface of the roadway to make energy transfer feasible. However, if the primary coils were at the road's surface, they would be exposed to wear and tear due to vehicular traffic and other environmental stresses.

Therefore, what is necessary is a feasible and an efficient way to transfer electric energy to an electric vehicle while the electric vehicle is in motion or while the electric vehicle is stationary.

### BRIEF DESCRIPTION OF THE DRAWINGS

Preferred and alternative examples of the present invention are described in detail below with reference to the following drawings:

FIG. 1 illustrates an exemplary embodiment of an electromagnetic induction energy transfer system;

FIG. 2 is a schematic diagram showing one embodiment of the electromagnetic induction energy transfer system;

FIGS. 3A-3C show exemplary inductive energy receiver material embodiments in the wheels of the electric vehicle; and

FIG. 4 illustrates an exemplary embodiment of the electromagnetic induction energy transfer system wherein the inductive cabling is in a sheet.

### DETAILED DESCRIPTION

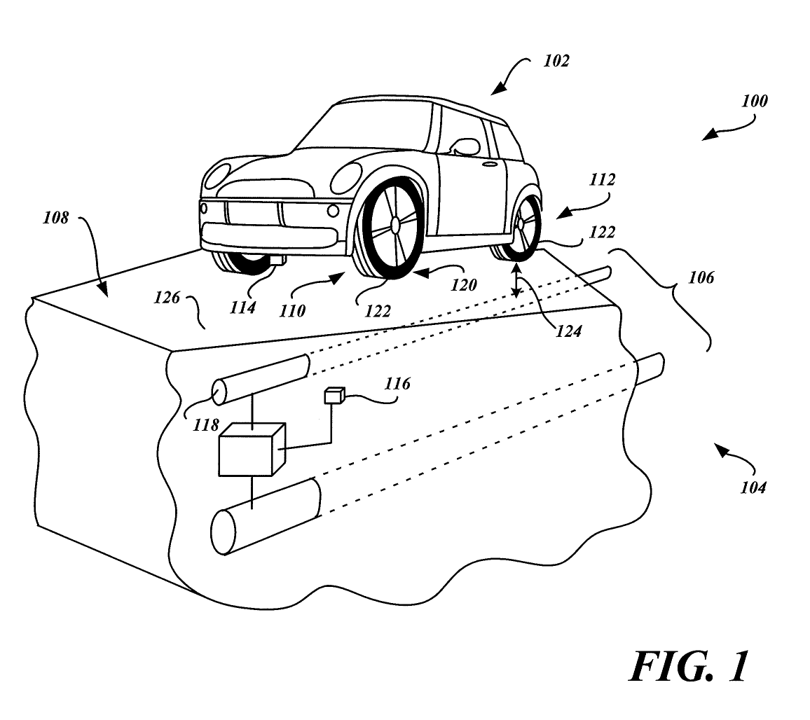

FIG. 1 illustrates an exemplary embodiment of a high power energy transfer system 100. Exemplary embodiments provide inductive electrical energy transfer to moving and/or stationary electric vehicles 102. Alternatively, or additionally, an exemplary embodiment may comprise an option for monitoring and billing for electric energy drawn from an electric energy source 104. Alternatively, or additionally, an exemplary embodiment may provide the ability to communicate data to and from the electric vehicle 102, optionally including such data as the amount of the energy used and/or a cost being incurred by the driver due for the energy transfer to the electric vehicle 102.

An exemplary embodiment comprises the system 100 for supplying electric energy to the electric vehicle 102. An exemplary embodiment may supply electric energy to the electric vehicle 102 while the electric vehicle 102 is in motion, in which an electric energy transmitting module 106 beneath a roadway 108 transmits electrical energy to the electric vehicle 102.

In the exemplary embodiment, the electric energy receiving component can be electric energy receiving modules 110 embedded in at least one of the plurality of front or rear wheels 112, and preferably embedded in all wheels 112 to maximize energy transfer. The electric energy receiving module 110 receives transmitted electrical power from the roadway electric energy transmitting module 106.

An onboard data receiving and transmitting device 114 is present in the vehicle and in communication with a roadway receiving and transmitting device 116. The onboard data receiving and transmitting device 114 communicates data, including but not limited to the amount of energy drawn from the roadway electric energy transmitting module 106. For example, in such a scenario, the energy source provider has the ability to bill the electric vehicle driver/user for the energy usage as the use occurs, and the driver/user of the vehicle 102 can likewise view the charge as incurred and opt to turn on/off the system 100 (run on batteries or accept charge).

Additionally, in exemplary embodiments the roadway electric energy transmitting modules 106 are operational if and when they are linked with, and/or are enabled with, the ability to communicate with and/or transmit billing information to the vehicle operator, and/or bill for use of electric energy drawn from the system for use by the electric vehicle 102. In an exemplary embodiment, if the electric vehicle operator does not wish to receive electric energy when traversing a roadway 108 enabled with electric energy transmitting modules 106, the vehicle operator can turn off the inductive electric energy receiving modules 110 and run from the onboard rechargeable energy storage system and/or other power system, such as a combustion engine or the like.

It is contemplated that while the system 100 provides electric energy to electric vehicles 102, thereby allowing the electric vehicles 102 to drive indefinitely without stopping to recharge the battery, (for example, never having to stop to “plug-in” the electric vehicle 102 as would be necessary in the prior art), the system 100 also provides a mechanism for the electric vehicle operator to “opt out” of the constant charging situation and running from the onboard rechargeable energy storage system 220. The electric vehicle operator has a choice to recharge the electric vehicle 102 at a later time, for example while stationary, and at potentially cheaper energy sources, for example at parking garages at non-peak energy use times during the day. Timing devices on the electric vehicle 102 could be set to recharge the electric vehicle 102 at times of the day when the energy supplied by the provider was at the lowest cost to the vehicle user.

In the exemplary embodiment illustrated in FIG. 1, the system 100 includes inductive cabling 118 that can be, for example, leased to a electric energy providing company who can then bill the electric vehicle operator for use of the energy transferred to the electric vehicle 102 while driving on the roadway 108 embedded with electric energy transmitting modules 106. In alternative embodiments, the wireless electric energy providing company can for example provide energy from a local energy source (e.g., solar, wind turbines, and the like) and/or from remote energy sources that can source energy to the energy transfer system 100 in the roadway 108.

In an exemplary embodiment, the wheels 112 of the electric vehicle 102 contain an inductive energy receiver material 120 (such as, but not limited to, a secondary coil), thereby decreasing the distance between the inductive cabling 118, acting at a primary inductive coil in the electric energy transmitting modules 106, and the inductive energy receiver material 120. By embedding the inductive energy receiver material 120 in the tires 122, and/or otherwise positioning the secondary coil in at least one of, but preferably all of the wheels of the electric vehicle 102, a distance 124 between the inductive energy receiver material 120 and the inductive cabling 118 may be reduced, or may even be minimized. In an exemplary embodiment, there is substantially no air gap between the roadway electric energy transmitting module 106 and the electric energy receiving modules 110 in the wheel(s) 112. Accordingly, peak power transfer over an absent air gap, or at least a minimized air gap, is not a significant problem that would otherwise require complicated compensation, as relatively large air gaps create a relatively large reluctance to the magnetic flux established between the roadway electric energy transmitting module 106 and the electric energy receiving modules 110.

By placing the inductive energy receiver material 120 (such as, but not limited to, a secondary coil) in the wheels 112 of the electric vehicle 102, the minimum distance between the inductive energy receiver material 120 and the inductive cabling 118 embedded in the roadway 108 is achieved. Further, the distance between the wheels 112 and the roadway 108 containing the electric energy source 104 stays relatively constant regardless of the clearance beneath the electric vehicle 102. In an exemplary embodiment, a maximum gap between the roadway electric energy transmitting module 106 and the electric energy receiving modules 110 of only five inches to seven inches is achieved. (For example, but not limited to, there may be two to three inches between the relevant portion of the inductive energy receiver material 120 in the wheel 112 and the road surface 126, plus three to four inches between the road surface 126 and the subsurface inductive cabling 118). The relative short separation between the roadway electric energy transmitting module 106 and the electric energy receiving modules 110 enhances, and may even maximize, the energy transfer potential. Additionally, the wheels 112 on virtually all electric vehicles 102 are designed to be roughly perpendicular to the road surface 126. This perpendicular configuration enhances, and may even maximize, the resonant energy transfer potential between the roadway electric energy transmitting module 106 and the electric energy receiving modules 110 in the electric vehicle 102.

In an exemplary embodiment, the inductive energy receiver material 120 (such as, but not limited to, a secondary coil) in the wheels 112 can be a post-manufacture add-on feature. For example, a copper, or other likewise highly conductive wire coil, rope, or the like can be used as the inductive energy receiver material 120 (e.g., secondary coils), thus maintaining the flexibility needed in a tire 122 of the wheel 112. In an exemplary embodiment, the conductive rope can be embedded in a post-manufacture rubber mat or the like to line the inside of the tire 122 of the wheel 112. Custom rubber mats are contemplated for different embodiments, providing an additional benefit of ease of manufacture and ease of installation and/or replacement. Additionally, in this embodiment, the implementation may not need to involve the tire maker. In this embodiment, the air pressure in the tire 122 keeps the rubber mat with the embedded secondary coils in place along the edges and the inner surface of the tire 122. In one embodiment, while in operation, wires from the rubber mat containing the inductive energy receiver material 120 connect to a conductive plate attached to the rim of the wheel 112. The first conductive plate connects to a similar, and secondary conductive plate on the wheel rim so that enough rubber and pressure are kept between the wheel rim of the wheel 112 and the tire 122 thereby effectively eliminating the risk of slipping or inadvertently connecting wires to the rim of the wheel 112. Alternatively, tire manufactures may, in other embodiments, embed the inductive energy receiver material 120 in the tire 122 itself.

The wireless electric energy receiving modules 110 and the energy reception system of the electric vehicle 102 uses the transferred electrical power to charge an onboard energy storage system or for direct use for propulsion of the electric vehicle 102. In alternative embodiments, the wireless electric energy receiving modules 110 in the wheels 112 can be used in conjunction with alternative electric energy receiving modules 110 which can be disposed at the bottom, top, or sides of the electric vehicle 102. It is contemplated that multiple energy sources (e.g., solar) can also feed into the onboard energy storage system.

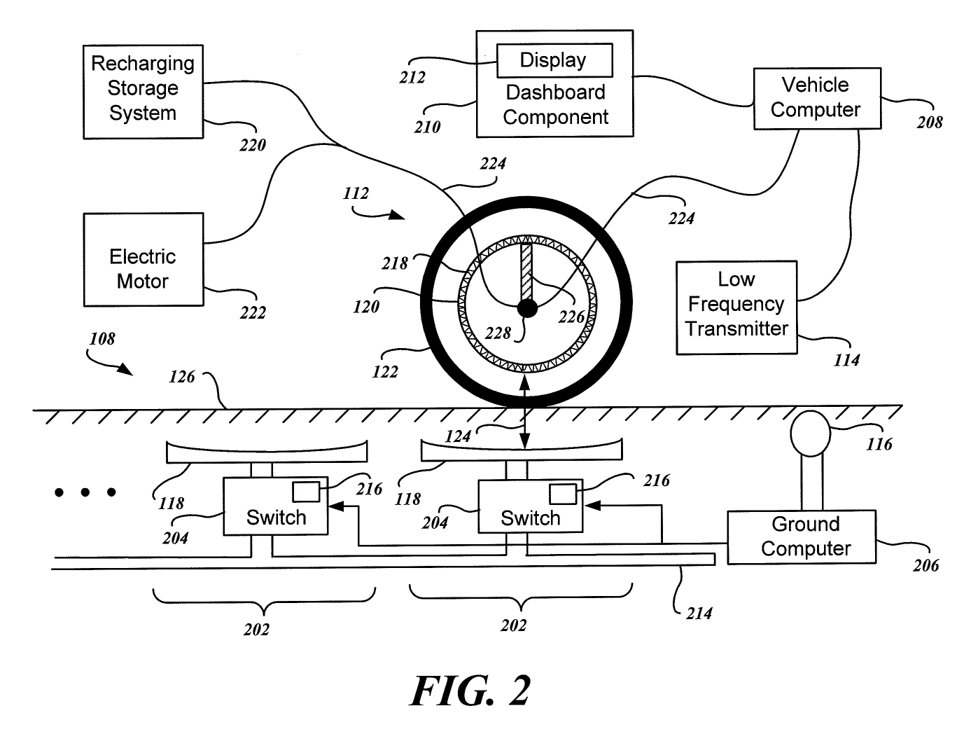

FIG. 2 is a schematic diagram showing one embodiment of the electromagnetic induction energy transfer system 100. In an exemplary embodiment, the inductive energy transfer system 100 is placed in or on the ground in a configuration to facilitate and/or optimize energy transfer to the electric energy transmitting module 106 of the electric vehicle 102 while the electric vehicle 102 is passing over the roadway 108. Embodiments of the electric energy receiving modules 110 can be configured to allow energy transmission to occur when the electric vehicle 102 is stationary or moving.

The onboard data receiving and transmitting device 114, which may be a suitable low frequency transmitter/receiver in an exemplary embodiment, sends data from the electric vehicle 102 to the roadway receiving and transmitting device 116 of the in-roadway electric energy source 104. The data, in part, identifies the wireless electric energy user, for example using by a unique identifier associated with the electric vehicle 102. Any suitable identifier may be used, such as, but not limited to, user account information, vehicle license and/or registration, and/or identifier data for the electric energy receiving module 110.

Additional data and information can be communicated between the roadway receiving and transmitting device 116 and the vehicle's onboard data receiving and transmitting device 114. The additional data and information may include, but not limited to, the electric energy received by the electric vehicle 102 for the purpose of billing the electric vehicle owner for the energy drawn from the electric energy transmitting module 106. The roadway receiving and transmitting device 116, which can be for example, embedded in the ground, can verify the identity of the energy user, for example, by the unique identifier of the electric vehicle 102.

In an exemplary embodiment, the energy transfer system 100 turns on/off a section 202 of the in-ground inductive cabling 118 through a junction component 204, such a switch or the like, controlled by a ground computer 206. In an exemplary embodiment, the roadway receiving and transmitting device 116 can send kilowatt rates to the electric vehicle 102 that is received by the onboard data receiving and transmitting device 114. The kilowatt rate corresponds to the cost of electric power provided by the electric energy transmitting module 106. The data sent by the roadway receiving and transmitting device 116 about the kilowatt rates, in this example, can be provided to the electric vehicle computer 208 and/or a dashboard component 210. The dashboard component 210 may include a user interface display 212 that is configured to graphically display the communicated data or information, such as the availability of power and/or the kilowatt rates.

The dashboard component 210 may also be configured to allow the electric vehicle operator to turn on, or turn off, the electric energy receiving modules 110 in the electric vehicle 102. For example, based on current charge availability and the current kilowatt rate, the user may elect to receive energy from the energy transfer system 100 in the event that the vehicle operator believes that charge is required for travel to their destination or a next one of the energy transfer systems 100, and/or in the event that the vehicle operator is willing to buy power at the offered kilowatt rate. That is, information communicated from the onboard data receiving and transmitting device 114 corresponds to an authorization by a vehicle operator corresponding to an acceptance of the electric power provided by the electric energy transmitting module 106 at the communicated kilowatt rate.

In an exemplary embodiment, the inductive cabling 118 sections can be placed underground (along the roadway 108) or in a protective housing on or below the surface 126 along the roadway 108. Additionally, or alternatively, the inductive cabling 118 may be placed in a location where the electric vehicle 102 is likely to be stationary, for example, in a parking lot, garage, and/or a charging station. In some embodiments, the inductive cabling 118 sections may be implemented as a permanent and/or portable charging mat and/or plate that can be plugged into a local outlet and placed under the wheels 112 of the electric vehicle 102.

In an exemplary embodiment, the inductive cabling 118 is connected to the cable junction component 204. When the cable junction component 204 is actuated by the ground computer 206, the inductive cabling 118 receives power from a power bus 214 that may be permanently energized. In one embodiment, the inductive cabling 118, when energized by actuation of the cable junction component 204, produces a magnetic field (not shown). The magnetic field extends over the distance 124 and is inductively coupled to the roadway electric energy transmitting module 106 and the electric energy receiving modules 110, thereby transferring electrical power from the power bus 214 to the electric vehicle 102. Accordingly, the electric energy receiving module 110 is configured to receive a portion of the magnetic field generated by the electric energy transmitting module 106, and is configured to produce electrical energy from received magnetic field.

In an exemplary embodiment, the cable junction component 204 is activated by the ground computer after a valid unique identifier associated with the electric vehicle 102 and/or the vehicle user has been received by the ground computer 206. That is, electric power is transferred to the electric vehicle 102 when the electric vehicle 102 is known to be authorized to receive electric power, and/or when the vehicle operator agrees to accept receipt of the electric power.

The power bus 214, such as a constant energy power cable or the like, can be placed in proximity to the inductive cabling 118 sections to provide power through the cable junction components 204. When the actuated cable junction components 204 are powering their respective inductive cabling 118 sections, their respective inductive cabling 118 sections are energized. When the cable junction components 204 are not actuated, their respective inductive cabling 118 sections are not energized, thus preventing electrical energy transfer when no valid unique identifier, and or operator acceptance, is transmitted by the onboard data receiving and transmitting device 114 to the roadway receiving and transmitting device 116. Further, because the length of the inductive cabling 118 sections may be designed so that only an authorized electric vehicle 102 in proximity to an energized inductive cabling 118 section receives power. Other electric vehicles 102 that may be near to the energized inductive cabling 118 section will not be sufficiently close enough to meaningfully capture any power.

For example, the junction components 204 can turn on and turn off the power from the power bus 214 to their respective inductive cabling 118 section in a serial fashion in the direction that the electric vehicle 102 is travelling over the roadway 108, thereby providing power over a duration that corresponds to the time that the electric vehicle 102 is able to receive a sufficient amount of power from the serially energized inductive cabling 118 sections. That is, when the electric vehicle 102 is moving down the roadway 108, the inductive cabling 118 sections may be serially turned on and turned off such that the electric vehicle 102 receives power over a duration that is sufficient to receive a meaningful amount of recharging.

In an exemplary embodiment, the cable junction component 204 may also be attached to and/or house a low frequency receiver 216 that receives data, including the identifier information related to the electric vehicle 102 when the electric vehicle 102 is in proximity to the electric energy transmitting module 106.

Alternatively, or additionally, the cable junction component 204 can house the roadway receiving and transmitting device 116 and/or a ground computer 206. Accordingly, the embodiment can validate the unique identifier from the vehicle/user, and can also receive the energy usage data of the electric vehicle 102. For example, but not limited to, the electric vehicle 102 may send energy usage data to the roadway receiving and transmitting device 116 in the junction component 204, and the roadway receiving and transmitting device 116 in the junction component 204 may send kilowatt rate information to the electric vehicle 102.

In an exemplary embodiment, the electric energy receiving modules 110 of the electric vehicle 102 contain a pick-up coil 218, or secondary coil, in the electric vehicle's wheels 112. The pick-up coil 218 is configured to convert the magnetic field generated by the electric energy transmitting modules 106 sourced by the provider (in/on the ground) into electrical energy that feeds into a recharging storage system 220 (e.g., battery, ultracapacitor, or other electric power storage device) and/or directly to the electric vehicle's electric motor 222 of the electric vehicle 102. At least one of the wheels 112 is rotated by mechanical power from the electric motor 222. The electric energy receiving modules 110 can also be turned on/off by the vehicle operator allowing “battery only” usage of the electric vehicle 102. The electric energy receiving modules 110, and/or the attendant pick-up coils 218, can be in any suitable shape to fit the purpose of the electric vehicle 102. It is anticipated that each wheels 112 can be built to receive the inductive energy from the energized electric energy transmitting modules 106.

In operation, one or more cables 224 from the wireless electric energy receiver modules may provide energy to the vehicles recharging storage system 220 and/or electric motor 222, and may also provide data including, but not limited to, energy usage and/or local energy rates to the electric vehicle computer 208. The cables 224 also provide a communication path between the electric vehicle computer 208 and the onboard data receiving and transmitting device 114 so as to allow the vehicle operator to turn off the electric energy receiving modules 110. The interface between the cables 224 and the vehicle's various systems can be a standard interface and/or a customized system. Depending upon the intended purpose of the cables 224, the cables 224 may be different.

In the various embodiments, the cables 224 are coupled to the electric energy receiving modules 110, and more particularly, to the pick-up coils 218, via a connector 226 that extends proximate to the hub of the wheel 112. A suitable rotatable coupler 228 between the connector 226 and the cable 224 permits power transfer from the electric energy receiving modules 110 to the cables 224 while the electric vehicle 102 is moving down the roadway 108. An exemplary rotatable coupler 228 may be, but is not limited to, a slip ring and brush system.

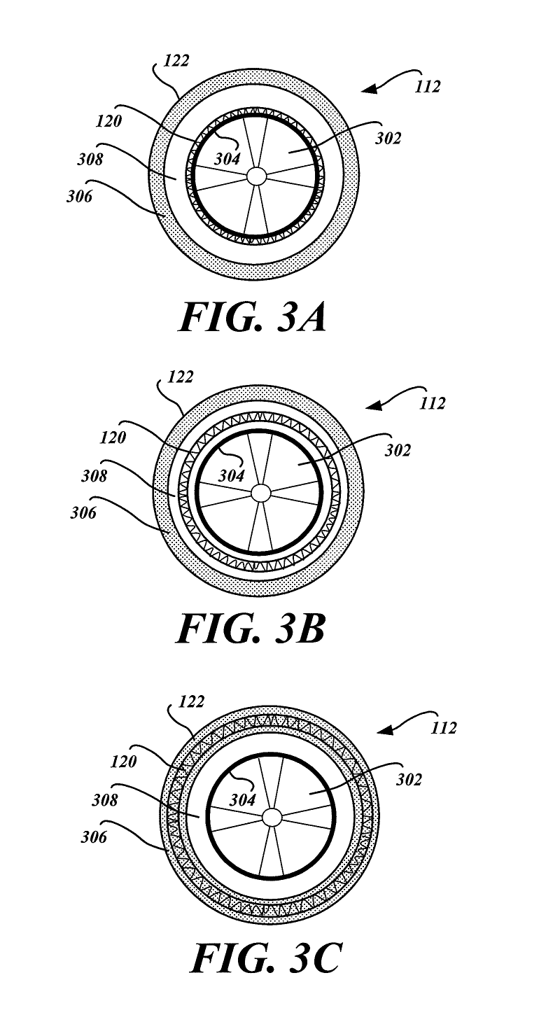

FIGS. 3A-3C show exemplary inductive energy receiver material 120 embodiments in the wheels 112 of the electric vehicle 102. The exemplary wheels 112 comprise a wheel rim 302 and a tire 122 secured to an outer periphery portion 304 of the wheel rim 302. An periphery portion 306 of the tire 122, when inflated by air residing in a cavity 308 cooperatively formed by the tire 122 and the wheel rim 302, is substantially rigid so as to support the electric vehicle 102 while the electric vehicle 102 is sitting on or traversing the road surface 126, or while the vehicle 102 is on another surface, such as while parked.

The inductive energy receiver material 120, in the exemplary embodiment illustrated in FIG. 3A, is affixed to, or is otherwise incorporated into or as part of, the outer periphery portion 304 of the wheel rim 302. Such embodiments are advantageous when standard tires 122 are used for the electric vehicle 102.

The inductive energy receiver material 120, in the exemplary embodiment illustrated in FIG. 3B, resides in the cavity 308. The inductive energy receiver material 120 may be placed within the cavity 308. Optionally, the inductive energy receiver material 120 may be optionally secured to an inner surface of the periphery portion 306 of the tire 122 and/or the outer periphery portion 304 of the wheel rim 302. Such embodiments are advantageous when standard tires 122 and standard wheel rims 302 are used for the electric vehicle 102.

The inductive energy receiver material 120, in the exemplary embodiment illustrated in FIG. 3C, resides inside the inner periphery portion 306 of the tire 122. The inductive energy receiver material 120 may be placed within the inner periphery portion 306 of the tire 122 during fabrication of the tire 122. Optionally, the inductive energy receiver material 120 may be secured to the inner surface of the periphery portion 306 of the tire 122 during fabrication or at a later time. Such embodiments are advantageous when standard wheel rims 302 are used for the electric vehicle 102.

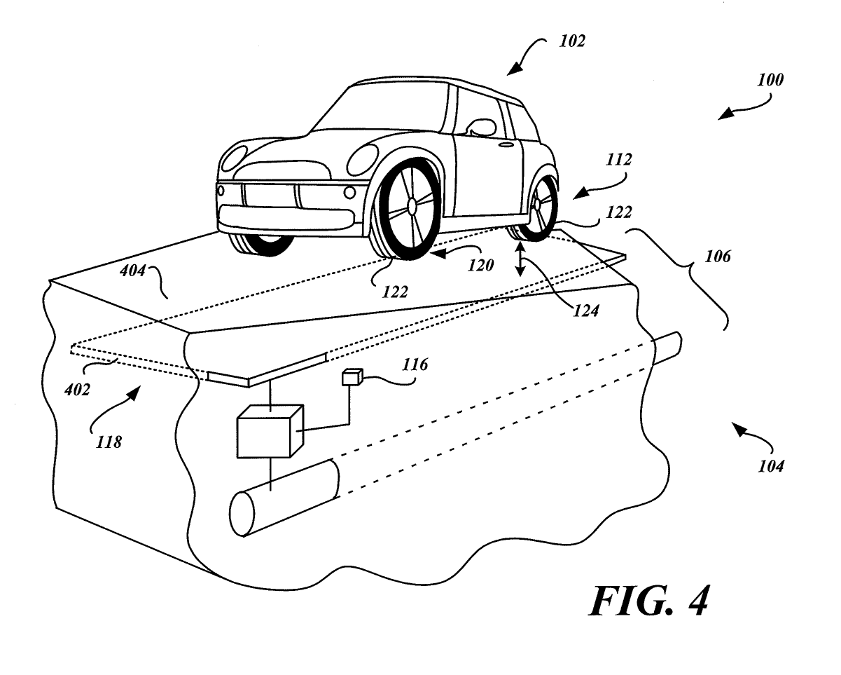

FIG. 4 illustrates an exemplary embodiment of the electromagnetic induction energy transfer system 100 wherein the inductive cabling 118 is in a sheet 402. The sheet 402 may be a mat or pad in an exemplary embodiment. The sheet 402 may be placed at a location where the electric vehicle 102 is likely to be stationary, for example, in a parking lot, garage, and/or a charging station. The sheet 402 may lie on a surface 404, or may be buried below the surface 404 as illustrated in FIG. 4.

In some embodiments, the sheet 402 may be configured to be electrically coupleable to a standard power source, such as an electrical outlet or the like, using a suitable connector, such as an extension cord or the like. In another embodiment, the sheet 402 may be wired to a suitable power source using a suitable connector.

While the preferred embodiment of the high power energy transfer system 100 has been illustrated and described, as noted above, many changes can be made without departing from the spirit and scope of the invention. Accordingly, the scope of the claims is not limited by the disclosure of a preferred embodiment of the high power energy transfer system 100.

1. A system for inductively transferring power to electric vehicles, comprising:
an electric energy transmitting module, wherein the electric energy transmitting module is on or below a road surface, and wherein the electric energy transmitting module is configured to establish a magnetic field above the road surface using electrical energy inductively received from an electric energy source; and
an electric vehicle comprising:
an electric motor;
a recharging storage system electrically coupled to the electric motor and configured to provide electric power to the electric motor;
a plurality of wheels, wherein at least one of the plurality of wheels is rotated by mechanical power from the electric motor; and
at least one electric energy receiving module residing in one of the wheels,
wherein the at least one electric energy receiving module is electrically coupled to at least the recharging storage system,
wherein the at least one electric energy receiving module is configured to receive a portion of the magnetic field generated by the electric energy transmitting module, and
wherein the at least one electric energy receiving module is configured to produce electrical energy from the received portion of the magnetic field.

2. The system of claim 1,
wherein the electric energy transmitting module comprises:
a roadway receiving and transmitting device; and
wherein the electric vehicle further comprises:
an onboard data receiving and transmitting device configured to receive first information from the roadway receiving and transmitting device, and configured to transmit second information to the roadway receiving and transmitting device,
wherein the second information comprises identifier information corresponding to an identity of the electric vehicle, and
wherein response to the electric energy transmitting module receiving the identifier information and determining that the electric vehicle is authorized, the electric energy transmitting module generates the magnetic field.

3. The system of claim 2, wherein the first information comprises a kilowatt rate that corresponds to a cost of electric power provided by the electric energy transmitting module, and wherein the second information further comprises an authorization by a vehicle operator corresponding to an acceptance of the electric power provided by the electric energy transmitting module that is provided at the communicated kilowatt rate.

4. The system of claim 2, wherein the electric energy transmitting module further comprises:
a power bus electrically coupled to a power source;
at least one inductive cabling section configured to generate the magnetic field; and
a ground computer communicatively coupled to the roadway receiving and transmitting device;
wherein the power bus is configured to energize the inductive cabling section after the identifier information has been received by the ground computer.

5. The system of claim 4, further comprising:
a cable junction component configured to electrically couple the power bus and the inductive cabling section, and wherein the cable junction component is controlled by the ground computer.

6. The system of claim 2, wherein the electric vehicle further comprises:
a dashboard component communicatively coupled to the onboard data receiving and transmitting device, and configured to communicate the authorization of the electric vehicle to the onboard data receiving and transmitting device.

7. The system of claim 1, wherein the electric energy transmitting module comprises:
a power bus coupled to the electric energy source; and
a plurality of inductive cabling sections arranged serially along a portion of a roadway traversed by the electric vehicle,
wherein each of the inductive cabling sections are configured to establish the magnetic field above a road surface using electrical energy received from the power bus.

8. The system of claim 7, wherein the plurality of inductive cabling sections are sequentially turned on and turned off as the electric vehicle passes over each of the inductive cabling sections.

9. The system of claim 7, wherein the magnetic field is configured to be substantially received by the electric vehicle, and wherein the magnetic field is not substantially receivable by other electric vehicles.

10. An electric vehicle configured to inductively receive electric power from an electric energy transmitting module, wherein the electric energy transmitting module is on or below a road surface, and wherein the electric energy transmitting module is configured to establish a magnetic field above the road surface using electrical energy received from an electric energy source, comprising:
an electric motor;
a recharging storage system electrically coupled to the electric motor and configured to provide electric power to the electric motor; and
an electric energy receiving module residing in a wheel of the electric vehicle.
wherein the electric energy receiving module is electrically coupled to at least the recharging storage system,
wherein the electric energy receiving module is configured to inductively receive a portion of the magnetic field generated by the electric energy transmitting module, and
wherein the electric energy receiving module is configured to produce electrical energy from the received magnetic field.

11. The electric vehicle of claim 10, further comprising:
an onboard data receiving and transmitting device configured to transmit first information to a roadway receiving and transmitting device, and configured to receive second information from the roadway receiving and transmitting device,
wherein the first information comprises identifier information associated with an identity of the electric vehicle, and
wherein response to the electric energy transmitting module receiving the identifier information and determining that the electric vehicle is authorized, the electric energy transmitting module generates the magnetic field.

12. The electric vehicle of claim 11, wherein the second information comprises a kilowatt rate that corresponds to a cost of electric power provided by the electric energy transmitting module, and wherein the first information further comprises an authorization by a vehicle operator corresponding to an acceptance of the electric power provided by the electric energy transmitting module at the communicated kilowatt rate.

13. The electric vehicle of claim 11, wherein the electric energy receiving module resides within a cavity cooperatively defined by a tire and a wheel rim.

14. The electric vehicle of claim 11, wherein the electric energy receiving module resides within an inner periphery portion of a tire.

15. The electric vehicle of claim 11, wherein the electric energy receiving module is affixed to a wheel rim of the wheel.

16. The electric vehicle of claim 10, further comprising:
a dashboard component configured to allow the electric vehicle operator to turn on and turn off the electric energy receiving module.

17. The electric vehicle of claim 10, wherein four wheels of the electric vehicle each include one of a plurality of electric energy receiving modules.

18. An electric energy transmitting module configured to inductively transfer power to an electric vehicle, comprising:
a power bus coupled to an electric energy source;
at least one inductive cabling section, wherein the inductive cabling section is on or below a road surface, and wherein the inductive cabling section is configured to establish a magnetic field above the road surface using electrical energy received from the power bus;
a roadway receiving and transmitting device configured to receive first information from an onboard data receiving and transmitting device of the electric vehicle, and configured to transmit second information to the onboard data receiving and transmitting device of the electric vehicle; and
a ground computer communicatively coupled to the roadway receiving and transmitting device, and configured to permit the power bus to energize the inductive cabling section,
wherein the first information includes at least a valid unique identifier associated with at least one of the electric vehicle and a vehicle operator, and
where in response to receiving the first information with the valid unique identifier, the inductive cabling section is energized by the power bus.

19. The electric energy transmitting module of claim 18, wherein the second information comprises a kilowatt rate that corresponds to a cost of electric power provided by the electric energy transmitting module, and wherein the first information further comprises an authorization by the vehicle operator corresponding to an acceptance by the vehicle operator of the electric power at the communicated kilowatt rate.

20. The electric energy transmitting module of claim 18, further comprising:
a cable junction component controlled by the ground computer, and configured to electrically couple the power bus and the inductive cabling section in response to actuation by the ground computer.
